(19) United States
(12) Patent Application Publication
(10) Pub. No.: US 2011/0043035 A1
(43) Pub. Date: Feb. 24, 2011

(54) Apparatus and methods for controlling light fixtures and electrical appliances

(76) Inventors: Jose Luiz Yamada, Houston, TX (US); Mark E. Lewis, Waller, TX (US)

Correspondence Address: Wisner & Associates;Suite 400, 1177 West Loop South, Houston, TX, 77027-9012, US

(21) Appl. No.: 12/800,288

(22) Filed: May 12, 2010

Related U.S. Application Data
(63) Continuation-in-part of application No. PCT/US2009/001734, filed on Mar. 19, 2009.
Application No. PCT/US2009/001734 is a continuation-in-part of application No. PCT/US2009/005272, filed on Sep. 22, 2009.

(51) Int. Cl. H02J 3/14

(52) U.S. Cl. 307/39

(57) ABSTRACT

Apparatus and methods for monitoring and controlling the energy usage of an installation including lighting fixtures, motors, compressors, and other electrical appliances by monitoring the operating status of the electrical appliances, switching the electrical appliances on and/or off as mandated by operating conditions, intended use(s) of the installation, ambient conditions, energy consumption limits, and other factors, reporting the operating status of the electrical appliances to a system coordinator, storing information as to the operating status of each electrical appliance in the installation to the memory of the system coordinator in a look-up table for subsequent retrieval as needed for operation of the installation, and transmitting a signal from the system coordinator that is operative to switch the electrical appliances on and/or off in accordance with the information stored in the look-up table.

The present application is a continuation-in-part of co-pending International Application Nos. PCT/US2009/001734, MODULAR, ADAPTIVE CONTROLLER FOR LIGHT FIXTURES, filed Mar. 19, 2009, and PCT/US2009/005272, POINT OF USE AND NETWORK CONTROL OF ELECTRICAL APPLIANCES AND METHOD, filed Sep. 22, 2009, the disclosures of which are hereby incorporated into this application in their entirety by this specific reference.

The present invention relates to efficient allocation of energy usage in lighting and other systems including electrical appliances that is achieved by flexible control and two-way communication with the lighting fixtures or other appliances of the system. In more detail, the present invention relates to apparatus and methods utilizing point of use laser, infrared (IR), and/or radio frequency (RF) control of lighting fixtures or other appliances in which the control commands communicated to the fixtures and appliances do not necessarily elicit a particular response from the fixtures or appliances to which it is transmitted depending upon such factors as the time of day, the amount of ambient light, the number of other fixtures or appliances, and many other factors.

The need for energy efficiency has driven innovation in the development of lamps for light fixtures and control systems for lighting fixtures. Fluorescent fixtures have been retrofit to many buildings in place of metal halide fixtures to reduce energy consumption. Although fluorescents have been improved by development of so-called T5 or T5HO fluorescent lamps and “quick start” ballasts and ballasts with electronic controls and significant energy savings have been achieved as a result of such developments, the improvement achieved by development of such lamps and ballasts has been only incremental over the many years that fluorescents have been in widespread use.

With respect to the control systems, remote on/off switching systems are available for switching a ceiling fan and/or light on or off in a room or building. So far as is known, however, the only such systems capable of distinguishing between multiple electrical appliances in a room or building are characterized by their operational limitations, complication, and/or their high installation cost. Such systems are available from, for instance, Sensor Switch, Inc. (Wallingford, Conn. and Port Perry, Ontario, www.sensorswitch.com), which markets a so-called “Hospital Bed Light Controller” that is retrofit to existing “pull chain” controlled hospital bed wall lights and operated by an infrared (IR) receiver/controller and an IR transmitter with a range of 8-10 feet. The advertising for the Hospital Bed Light Controller claims that a nurse with one remote can control all the wall lights on the ward or floor of the hospital. Though useful for use in a small room, the range limitations of this system do not allow for effective use unless the operator is close to the wall lights.

U.S. Patent Publication No. US2005/0025480 describes a laser-activated photoresistor for on/off switching, but a photoresistor is too slow acting for many applications and merely switches on/off with no operating flexibility. Further, the laser-activated photoresistor is susceptible to ambient light such that switching can occur as a result of, for instance, a flashing light or even incident sunlight. The slow response of the photoresistor severely limits the useful range of the remote for this system due to incremental laser movements resulting from shaking or natural movements in hand held operations. U.S. Pat. No. 6,252,358 (and many other systems) use radio frequency (RF) control to switch fixtures, but such systems are complicated and therefore not well suited for use in commercial installations in which many fixtures must be controlled. Further, RF systems are not targeted to specific fixtures and/or individual lamps or groups of lamps such that in the absence of encoding of the RF signal (and the resulting complexity of operation), fixtures are switched that are not intended to be switched.

U.S. Pat. Nos. 4,897,883 and 6,828,733 disclose handheld JR transmitters said to be capable of switching individual fixtures. However, the systems described in those patents utilize encoded IR signals and pre-programmed, separately addressable IR receivers mounted to the fixtures controlled from the handheld transmitter to switch the fixtures, requiring increased operational complexity and cost of installation, especially in installations with many fixtures. So-called DALI (digital addressable lighting interface) systems are available (for instance, from Specialized Lighting Solutions, Beaverton, Oreg., and Complete Technology Integrations Pty Ltd, North Ryde, NSW). Although impressive in their capabilities and operational flexibility, such systems are expensive to purchase and install, may require specialized programming or re-programming when changes are needed in a particular installation, and are operationally complex. Other systems require calibration processes at the time of installation and complex operating instructions that are programmed into a central controller such that they cannot be operated by anyone other than trained operators and must be re-programmed, often requiring on-site visits by the installer, when changes are made in the manner in which the space lighted by such systems is used for a different purpose.

Many existing controls elicit a specific response for a specific command. Therefore, by using existing control systems, large groups of fixtures can be turned on or off as a response to an on or off command. Some such systems control groups of fixtures that are on the same circuit. This method is fast, but lacks the ability to customize the control of fixtures on the same circuit, thereby losing possible energy savings from customization. By using technology such as DALI, custom lighting arrangements can be achieved through issuance of commands to individually addressed fixtures or ballasts. RF wireless networks that have the capabilities of addressing commands to an individual appliance through an addressable RF module are also available. Although having the advantages of being wireless, these systems have similar operational limitations as DALI. They are characterized by the complexity of programming, commissioning, and operation and have longer response times for customized settings when controlling large numbers of fixtures.

Another problem that has arisen has been created by the financial incentives and/or regulatory requirements of energy conservation and consumption. Many public utilities are offering favorable rates and other incentives to power purchasers, especially large purchasers, that agree to limit consumption during times of peak demand and/or that agree to decrease consumption upon receipt of notification from the power producer and/or carrier. Electrical rate charges are for commercial purchasers are sometimes based on peak consumption such that a purchaser may be able save money by decreasing peak consumption and tax incentives are also offered to such purchasers, all of which act as incentives for limitation and/or reduction in consumption that create a demand for control systems capable of reducing power consumption. In some areas, power consumers are actually limited in the amount of electricity, or load, they can utilize at any given time, creating a demand for systems for controlling consumption, and it is an object of the present invention to provide such systems.

It is also an object of the present invention to provide a system for controlling lighting fixtures and other electrical appliances that is capable of documenting, or providing verification, that power consumption has been limited and/or reduced as required for such purposes as qualifying for favorable electrical rates and/or tax incentives.

Another object of the present invention is to provide an apparatus for monitoring the operational status of the individual fixtures in a lighting system for such purposes of planning the maintenance of the fixtures and/or to switch different lamps and/or fixtures on or off in the event inappropriate readings that might indicate failure or other problems are reported from an individual fixture.

Another object of the present invention is to provide an apparatus and method for controlling lighting fixtures and other electrical appliances that reduces, and in some instances, even eliminates the need for operator intervention for some inputs that affect operating status by providing a set of operating rules that are implemented by a controller for, for instance, over-riding a signal from an ambient light sensor that is received during night-time hours such that essential night-time lighting is not switched off.

Another object of the present invention is to provide a lighting control system, and a system for controlling electrical appliances other than lighting systems, in which the lighting fixtures and/or electrical appliances respond to signals from a hand-held remote control, external inputs that do not require operator intervention, or a system controller in accordance with a pre-programmed set of operating rules so that a simple commands such as “select operating state 6” can be used to control some or all the fixtures and/or appliances in the system.

Another object of the present invention is to provide a lighting control system, and a system for controlling electrical appliances other than lighting systems, in which multiple fixtures and/or appliances can be set to a selected operating state (“select operating state 6”) in accordance with pre-programmed operating rules and/or by an operator that then assumes subsequent operating states in accordance with the pre-programmed operating rules in accordance with certain external inputs, for instance, the system assumes “operating state 7” at 7:00 am and/or, if system power consumption is limited and certain ventilating fans, for instance, that are included in the system are switched on by an operator while the system is in “operating state 7,” selected lighting fixtures (selected by the pre-programmed operating rules) are switched off so as to maintain system power consumption below the system limit.

Another object of the present invention is to provide a lighting control system, and a system for controlling electrical appliances other than lighting systems, that is “self-learning” in the sense that the individual fixtures and/or appliances can be set to desired operating status by an operator and their operating status is then sampled and saved by a system controller for recall either in accordance with pre-programmed operating rules and/or at the operator's command to cause the individual fixtures and/or appliances to again assume the same operating status to which the fixtures/appliances were set by the operator.

Yet another object of the present invention is to provide a method and apparatus that switches light fixtures and other electrical appliances on and/or off as needed to limit electrical power consumption in accordance with pre-programmed rules for insuring compliance with conservation, financial, and/or regulatory incentives for efficient power consumption, reduction of consumption at peak load times, and/or for conservation purposes.

Another object of the present invention is to provide a system for switching electrical appliances in a wireless or wired control network as described in co-pending International Application Nos. PCT/US2009/001734, MODULAR, ADAPTIVE CONTROLLER FOR LIGHT FIXTURES, filed Mar. 19, 2009, and PCT/US2009/005272, POINT OF USE AND NETWORK CONTROL OF ELECTRICAL APPLIANCES AND METHOD, filed Sep. 22, 2009, both commonly owned with the present application.

This listing of several of the objects of the present invention is intended to be illustrative, and is not intended to be a complete listing of all of the objects of the invention; instead, this listing of several objects of the present invention is intended to be illustrative in the sense that the invention addresses many needs and solves many problems, not all of which are listed here, and that are known in the art. Other objects, and the many advantages of the present invention, will be clear to those skilled in the art from the detailed description of the embodiment(s) of the invention and from the drawings appended hereto. Those skilled in the art will recognize, however, that the embodiment(s) of the present invention described herein are only examples of specific embodiment(s), set out for the purpose of describing the making and using of the present invention, and that the embodiment(s) shown and/or described herein are not the only embodiment(s) of a light fixture constructed in accordance with the teachings of the present invention.

Referring now to the figures,

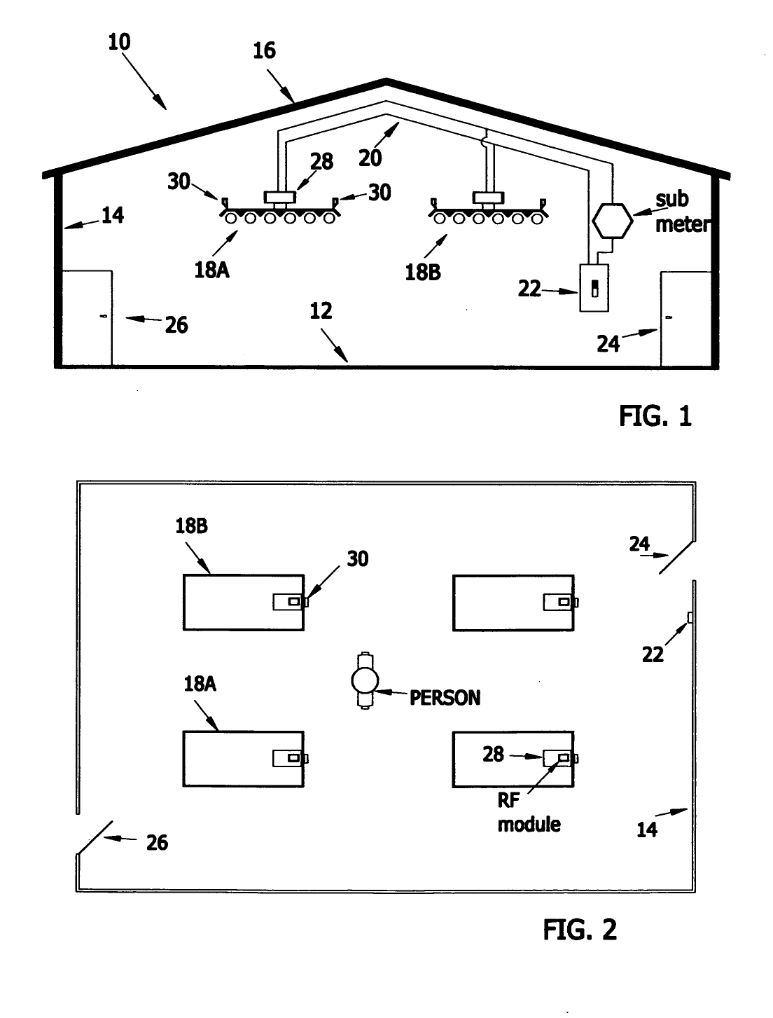

FIG. 1 shows a diagrammatic view of an open-frame building with high bay lights installed and wired in a manner commonly utilized in which the method and apparatus of the present invention is advantageously installed.

FIG. 2 shows a plan view of the building of FIG. 1.

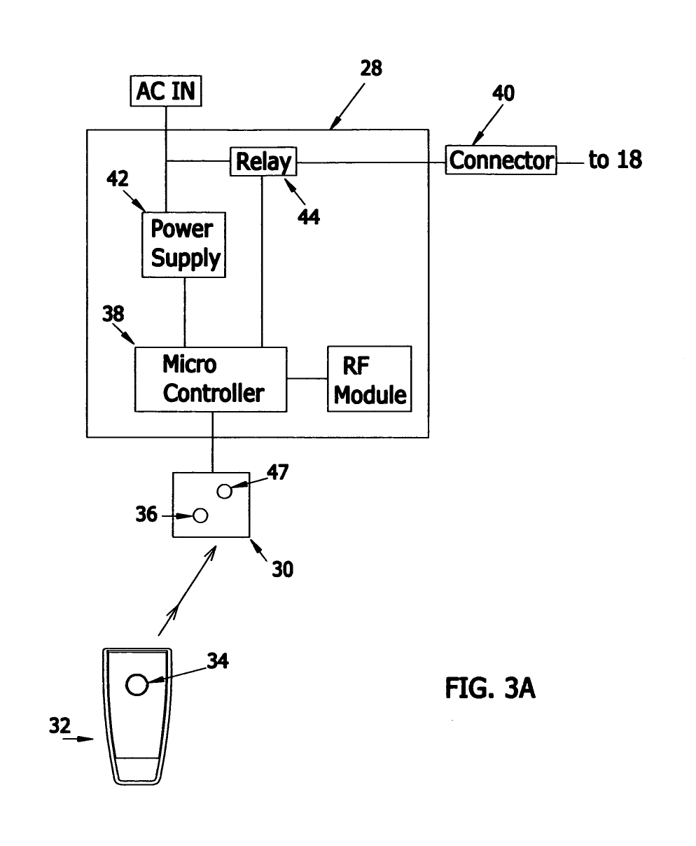

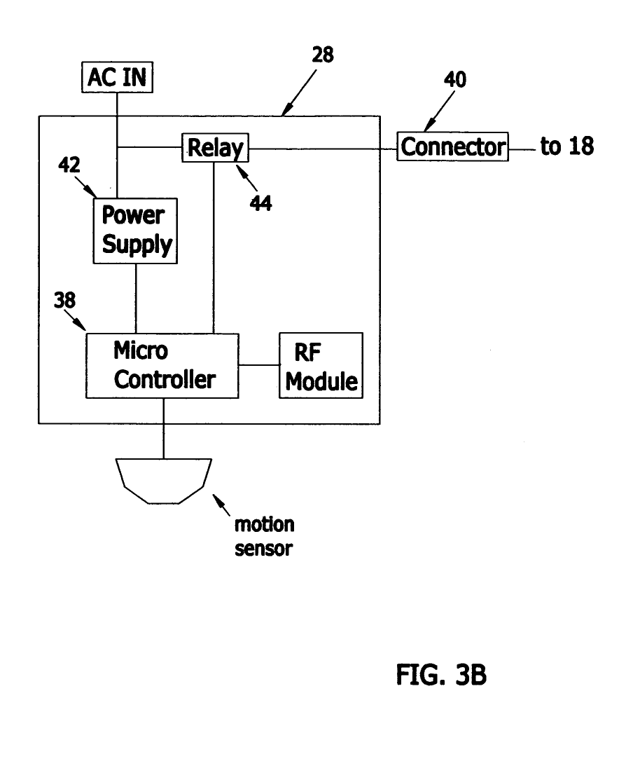

FIGS. 3A and 3B are schematic views of two embodiments of a switch controller comprising the apparatus of the present invention.

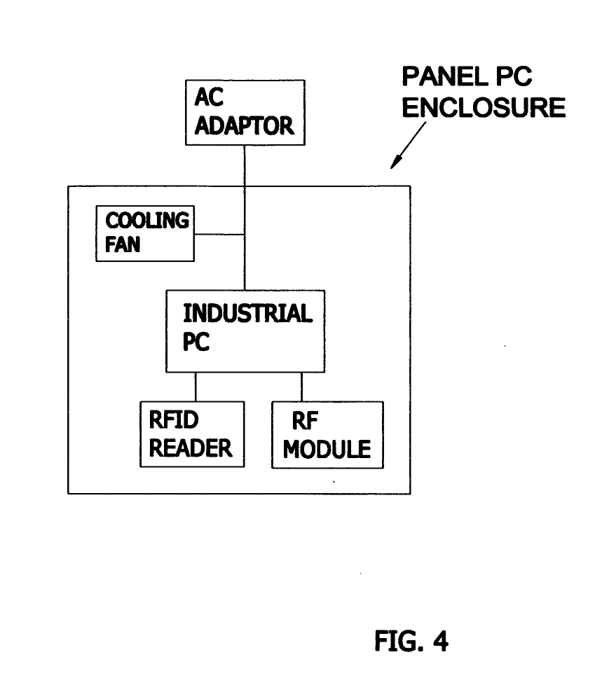

FIG. 4 is a schematic view of a controller for a lighting system that is constructed in accordance with the teachings of the present invention.

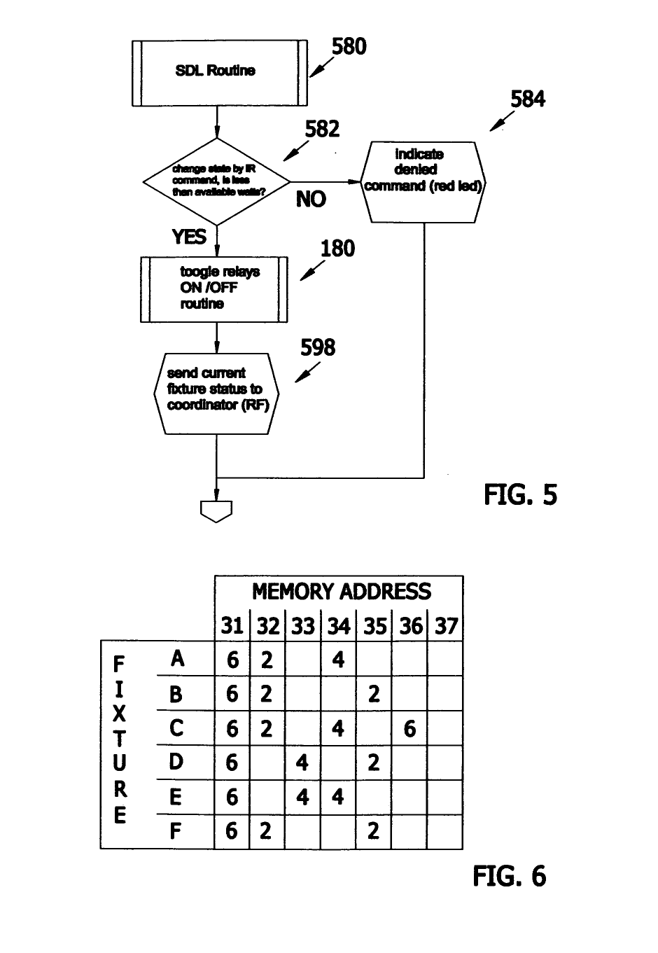

FIG. 5 is a diagram showing one embodiment of logic of the switch controller shown in FIGS. 3A and 3B.

FIG. 6 is a schematic diagram of a data table illustrating one way to organize the operating rules stored in the memory of the controller of FIG. 4.

Figure [TO BE COMPLETED]

The present invention provides what is referred to herein as Smart Demand Limits. This feature allows authorized system users to set consumption and demand limits for the energy use of devices controlled by the system. This limit can be changed by an authorized administrator as a response to, for instance, changes in building use or incentives for energy conservation. Many such governmental and energy company incentives exist, such as EPACT, to encourage installation of energy saving lighting systems capable of reducing consumption as well as demand during peak demand emergencies. This feature allows for the allocation of lighting in areas where it is most needed by limiting consumption in areas of less need through the individual step dimming controls of the present invention. Upon determination of the maximum wattage available at a given time, the method and apparatus of the present invention limit consumption in accordance with the following method.

A system coordinator monitors energy consumption based on the rated consumption of the lamps (54 watts for each T5HO, for instance) or through the actual measured system consumption by either a power submeter (such as Electro Industries Shark 100) that reports energy use or through a current sensing devise placed in each individual fixture. For the purpose of illustration, and using the rated power consumption method, if the particular installation in which the lighting system is installed is a manufacturing building of 20,000 square feet (sf) that must achieve a lighting power density of 0.55 Watts per sf, the building would need to limit electrical consumption to 11000 watts per hour or 203 T5 HO lamps in order to comply with the needed efficiency standard. If the building is equipped with 40 T5 6-lamp fixtures with a potential power consumption of 12960 watts (if all lamps are operating), the Administrator sets 203 lamps as the Smart Demand Limit. During manual or automatic operation, each fixture/switch controller has recorded to memory the last coordinator generated balance (203 minus 200 in use=3 available balance) of lamps available to the system. If the available balance is greater than an operator-requested IR remote command (switch two lamps on, for instance) the fixture controller allows the execution of command and communicates to the coordinator to switch two additional lamps on. The coordinator adds to lamps in use and subtracts from total available to generate a new available balance (203−202=1), then broadcasts the new balance to the network for recording to the memory of each fixture. As each individual fixture changes state of operations, it anticipates the expected response from the coordinator. If the response is not received during an allotted period of time, the fixture re-sends the reported usage and again awaits the expected response. The communication is broadcast throughout the network and each fixture updates the available balance. In the absence of an approved coordinator response, each of the fixtures returns to its previous and lower state of operation.

A repeater, or point of use network control, feature is limited to prevent exceeding the pre-selected limit for the installation. In this example, each fixture only executes repeater commands up to four lamps, therefore effectively limiting system use in that modality to 160 lamps. Each receiver is equipped with a target green LED that serves both as a target and an indication that there is available capacity in system and a red LED that is energized when the Smart Demand Limit ceiling is reached. The operator must then shed demand in another area to free up capacity in the desired area. Through this and other logic steps, the system prevents inadvertent or intentional power consumption that exceeds the established limits. Rules are operative in the individual fixtures as well as in the coordinator and are therefore enforced even in the absence of a properly functioning coordinator. When using actual measured consumption, either by submeter or current sensing devise on individual fixture, controls operate on the same logic, i.e., Max watts=11000−Current Usage 10,000 watts=1,000 watts available.

The advantages of this new level of control are far reaching. With the Smart Demand Limit feature in place, all custom programming of the Self Learning features with comply with the established system limits. By means of a System Use Documentation procedure, data is compiled on the operation of each set of lamps in each fixture for the purpose of continual improvement in measured performance and for such purposes as validating manufacturer's warranties and documentation of compliance with governmental regulations and incentives and/or power distributor incentives and/or restrictions. This feature also allows for the maximization of the useful life of the lamps and other components, thereby reducing the impact of equipment disposal on the environment.

In a second embodiment, the present invention provides what is referred to herein as a Custom Response Feature that allows for rapid control of many fixtures, each going to a custom setting that may be different from other fixtures wired in the same circuit, upon issuance of a single command. In seconds, thousands of fixtures can go to individually customized settings on a single command from the centralized controller or with a point of use remote transmitter. This feature allows for the maximization of energy savings through custom lighting arrangements and can extend the useful life of the equipment, thereby reducing the environmental impact of premature equipment disposal. The advantages of this enabling technology are far reaching. For example, on a single command, hundreds of luminaries can be dimmed, HVAC systems load reduced, or exhaust fans slowed as an immediate, appliance-specific, custom response to a single demand response command. Another advantage of this new method is ease of programming, commissioning, and change of custom settings as a response to environmental changes, facility use changes, or for the normal lumen degradation of luminaries. This capability addresses major problems associated with the commissioning and operation of systems with daylight harvesting, occupancy or vacancy sensing, and other forms of control inputs. A common problem with the operation of existing lighting systems and controls is that the programming and commissioning of the system is so complex that users bypass the controls to operate the fixtures manually. When they do so, intended energy savings are lost because the operator(s) are unable to adjust, calibrate, and re-commission the system, and this Custom Response Feature, which works through a process of data storage and logic that is fixture controller centered solves this problem.

In one embodiment, this Custom Response Feature is implemented by switching each individual fixture/appliance to a setting that optimizes lighting and energy savings and this switching is performed through point of use control or through centralized control. Each fixture appliance records to memory its current operating state and other data to a specific memory address on command. The command can originate from a centralized controller (coordinator) or from a hand-held transmitter with programming capabilities. During automatic control, the control command for each fixture is read and the data stored at a specified memory address. Each fixture controller reads, interprets, and executes based on the data recorded at that specific memory address. An example of the simplicity and effectiveness of this method is shown by a custom setting that safely and immediately reduces consumption for peak demand response. If, for instance, an installation has contracted with a utilities company to shed 50,000 watts of peak demand on instructions, that decrease in consumption is achieved, for instance, by dimming fixtures to a level that achieves the reduction without compromising safety and/or by reducing the speed of ventilating fans to a level that achieves the reduction called for by contract. The system user sets the lighting at the desired safe level, sets other appliances at energy saving settings, and issues the command for the fixtures/appliances to record the settings to a specific memory address, for instance, address D1. In this illustration fixtures are operated at different levels of lighting according to use and safety considerations. Upon receipt of the Demand Response Command from the utility company or governmental agency, the system issues the Custom Response Feature command “read D1.” Each fixture/appliance then reads the data found in that memory address and responds accordingly. The facility has safely shed the required demand within seconds. Calibrating or re-commissioning is achieved by making changes to the system and issuing a new command to store data to D1, overriding the previous recorded data at that address.

Calibration and re-commissioning is an important aspect of lighting system design and the present invention is utilized to particular advantage for these processes, and can be done by different operators and at different levels, with testing and compliance at each level. The calibration and commisioning process uses point of use control and the experiencial measurements for each level of decision makers/operators. For example, the Lighting Designer, Building owner, Tenant, Safety Manager, Sustainability Manager, and other personnel may all have input as to the lighting needs (or ventilation needs, or the needs of other electrical systems in an installation) for a particular installation, and because the programmer can make changes at the point of use that can be immediately evaluated for safety concerns, operational preferences, and such issues as whether energy savings objectives/limitations are being met.

Referring to the figures, FIGS. 1 and 2 show a schematic drawing of an open bay building 10 including a light installation of a type in which the present invention is used to advantage. The lighting installation includes lighting fixtures 18A and 18B which are shown as six-lamp fluorescent fixtures, but those skilled in the art will recognize that the fixtures can be any type of lighting fixture, having respective switch controllers 28 mounted thereto. Fixtures 18A and 18B and their respective controllers 28 are wired into a circuit 20 that includes a coordinator 22 and separate submeter. As shown in FIG. 2, the particular installation may include four fixtures 18, each with a respective switch controller 28, each switch controller 28 including a transceiver in the form of an RF module that is electrically connected to the respective switch controller for detecting a signal from an external input, transmitting a signal from the fixture 18 indicative of the operating status of the fixture 18 that outputs signals to switch controller 28 upon detection of a signal from an external input.

Referring to FIGS. 3A and 3B, two embodiments of the switch controller 28 are shown schematically. The first embodiment (FIG. 3A) includes a target 30 that includes a target LED 36 at which the laser or infrated hand-held remote 32 is aimed, the button 34 on remote 32 producing an encoded signal that is detected at target 30, and an indcator LED 47 that provides visual confirmation to the operator of receipt of a signal from remote 32. The second embodiment (FIG. 3B) substitutes a motion sensor for the target module 30 for detecting a passing vehicle or person and producing an output that is detected at microcontroller 38 of switch controller 28 to cause certain action in accordance with operating rules that pre-programmed into the memory of microcontroller 38 through operation of relay 44, which is connected through connector 40 to one or more of the lamps of fixture 18.

Referring to FIG. 4, a system coordinator that may be, for instance, mounted on the wall 14 of building 10 (FIG. 1) for use with the lighting installation is shown schematically. The coordinator includes a dedicated computer, for instance, a touch screen computer (labeled as an industrial PC in the figure), the usual cooling fan and AC adapter, a panel PC adapter to facilitate wall mounting, and in addition to the touch pad, such inputs as an RFID reader and an RF module. The latter includes both send and receive functions for communicating via RF to the fixtures 18 in the installation and the former is simply another input, in much the same manner as the motion sensor shown in FIG. 3B, in the sense that upon detection of an RFID tag (passive or active), the coordinator issues a command that causes the fixtures 18 in the installation to switch on, switch off, or do nothing at all in accordance with pre-programmed operating rules stored in the memory of the coordinator. Further, the command issued by the coordinator may vary in accordance with the particular RFID tag detected by the RFID reader such that upon detection of an RFID tag carried by, for instance, a security guard, light fixtures may switch on in a dark warehouse so that the security guard can safely make the rounds of the appointed checkpoints of the installation or a shift worker who arrives at the installation in the morning and needs lights switched on at his/her work station for performance of work duties. Of course the same coordinator may have several sets of commands stored in memory in accordance with the pre-programmed operating rules such that multiple shift workers, each carrying their own RFID tag, may be detected at the coordinator and light fixtures switched on and or off in accordance with the operating rules.

The control logic for the operating software for the microcontroller 38 of each switch controller 28 is shown in FIG. 5 and the description of that logic set out in the above-incorporated prior applications is referenced for the details of that logic. FIG. 6 illustrates a look-up table corresponding to the fixtures A-F in the installation with memory addresses 31-37 being illustrated and the number of lamps to be switched on in each fixture being set out in the table in accordance with the pre-programmed operating rule stored at each respective address in the memory of the coordinator.

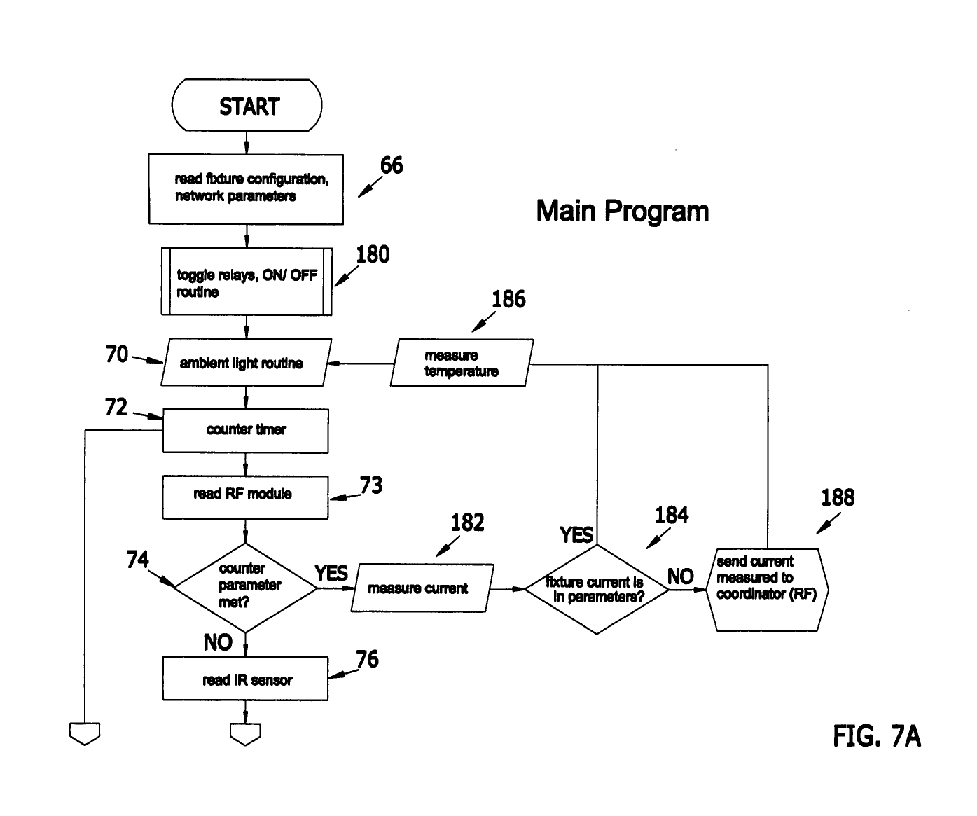

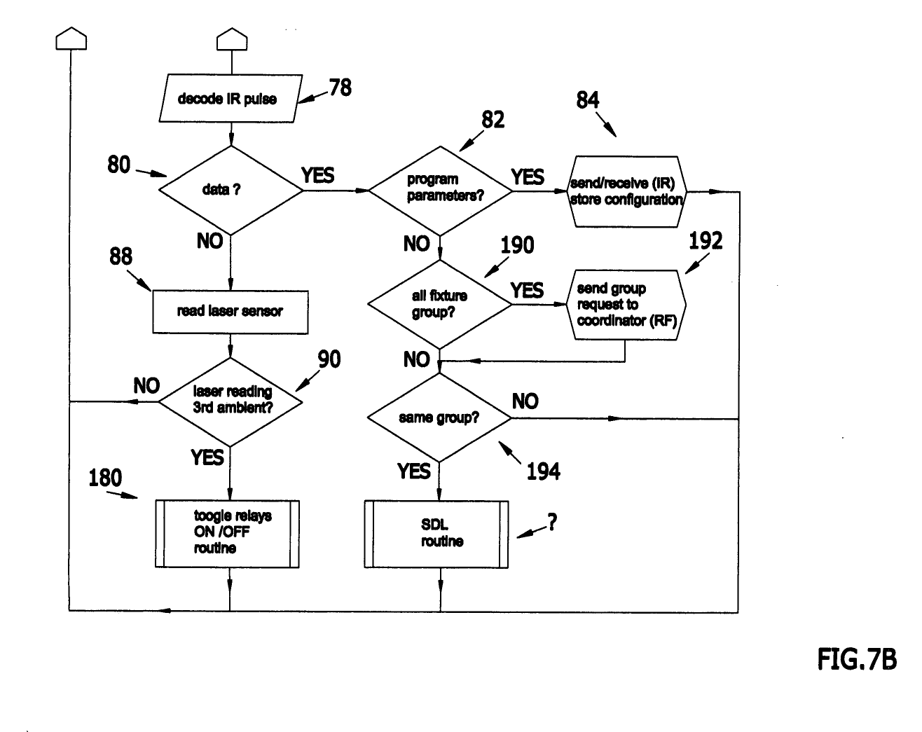

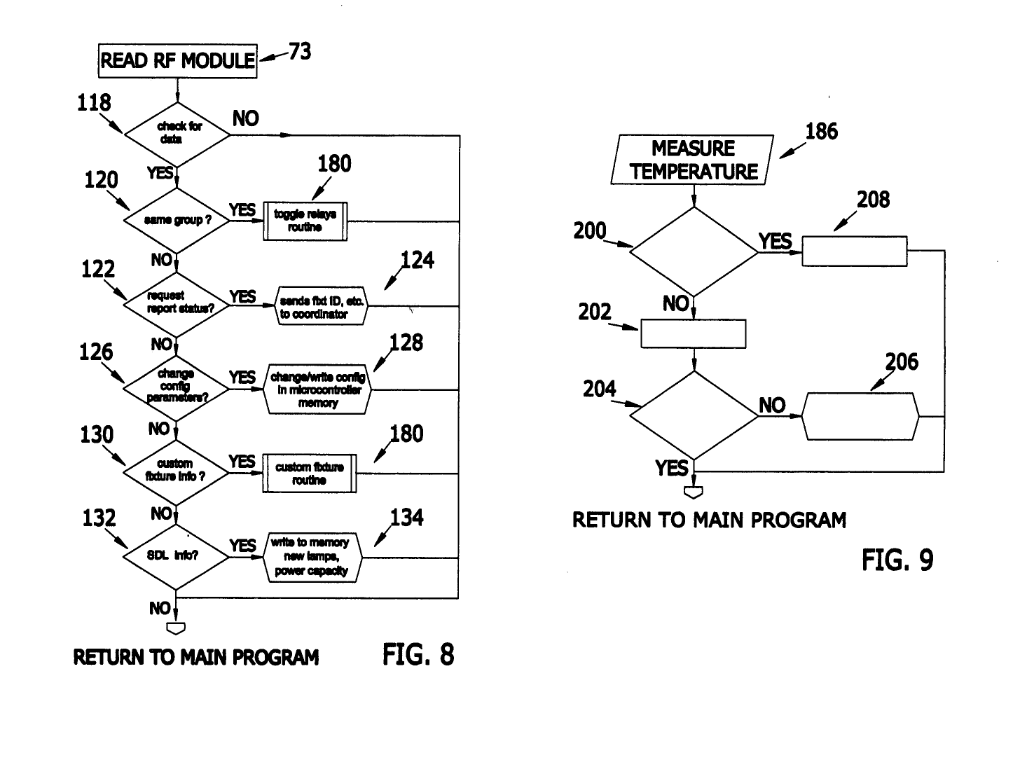

FIGS. 7A-7B, 8, and 9 illustrate the control logic for the operating software for the main program (FIGS. 7A-7B) and subroutines for input from the remote 32 or coordinator (FIG. 8) and an external input such as a temperature sensor for regulating the temperature of the ballast in the fixture 18, each in accordance with the detailed description of that logic set out tine above-incorporated prior applications.

Those skilled in the art who have the benefit of this disclosure will recognize that changes can be made in the specifics of the operation of the present invention that do not change the manner in which the objects and advantages of the invention as described herein are accomplished. All such changes are intended to fall within the scope of the following, non-limiting claims.

What is claimed is:

1. Apparatus for controlling electrical appliances comprising:
a switch controller mounted to an electrical appliance;
a transceiver connected to said switch controller for (a) transmitting a signal to said switch controller for operating the electrical appliance when said receiver detects an external input and (b) producing a signal indicative of the operating status of the electrical appliance;
operating logic stored in the memory of said switch controller comprising a set of pre-programmed operating rules for either switching the electrical appliance on, switching the electrical appliance off, or not switching the electrical appliance upon receipt of a signal from said receiver; and
a system coordinator for sending and receiving signals from said transceiver in accordance with a set of pre-programmed operating rules responsive to the number of electrical appliances to be controlled, the energy usage of the electrical appliances to be controlled, and the energy available for use by the electrical appliances to be controlled.

2. A method of allocating energy usage in an installation including one or more electrical appliances, a controller for switching each of the electrical appliances on and/or off, a system coordinator having a set of pre-programmed operating rules stored in the memory thereof, and means for communicating between the system coordinator and the switch controller comprising the steps of:
(a) setting a limit on the energy usage by the installation;
(b) switching the electrical appliances on and/or off in accordance with the needs of the installation;
(c) communicating the operating status of the electrical appliances to the system coordinator;
(d) comparing the energy usage of the electrical appliances in the installation to the energy usage limit;
(e) if energy usage exceeds the energy usage limit, switching electrical appliances off to decrease energy usage;
(f) repeating steps (b)-(e) until energy usage is lower than the limit set in step (a); and
(g) storing the operating status of the electrical appliances in the installation to a look-up table in the memory of the system coordinator for subsequent retrieval and use in limiting energy usage of the installation.
